(19) United States
(12) Patent Application Publication
(10) Pub. No.: US 2026/0329590 A1
(43) Pub. Date: Oct. 22, 2026

(54) DYNAMIC ADJUSTMENT OF SYSTEM CONFIGURATION OVER A REMOTE INTERFACE IN RESPONSE TO VULNERABILITIES OR EXPOSURES

(71) Applicant: Dell Products L.P., Round Rock, TX (US)

(72) Inventors: Brian Rochford, Ovens (IE); Andrea Roggerone, Dublin (IE); Steven Soumpholphakdy, Austin, TX (US)

(21) Appl. No.: 19/058,685

(22) Filed: Feb. 20, 2025

(51) Int. Cl. G06F 9/445

(52) U.S. Cl. CPC G06F 9/44505

(57) ABSTRACT

Dynamic adjustment of system configuration over a remote interface in response to vulnerabilities or exposures (e.g., using a computerized tool), is enabled. For example, a system can comprise at least one processor and at least one memory that stores executable instructions that, when executed by the processor, facilitate performance of operations. The operations can comprise receiving, from a supplier entity device associated with a remote appliance device, a remote appliance device configuration update applicable to a common vulnerability and exposure (CVE) publication applicable to the remote appliance device, and applying the remote appliance device configuration update to the remote appliance device.

### BACKGROUND

Storage and compute appliances require an operating system to manage and enable interfaces to the underlying hardware of the appliance. In most cases, the operating systems used in such enterprise appliances are Linux-based. Using Linux-based appliances enables enterprises to leverage a powerful, flexible, and cost-effective solution for their corresponding appliance needs.

One impactful downside to leveraging Linux-based operating systems is that any common vulnerabilities and exposures (CVEs) that are discovered in the underlying operating system will inherently be present in the appliance. Upon identification that an appliance is vulnerable to a CVE, the vulnerability or exposure should be addressed in a timely manner to mitigate the exposure to that CVE. However, it is difficult to generate a security patch (e.g., modifying kernel code) in a short period of time -there is a significant amount of development and validation time required to update an underlying operating system. A long lead time for a CVE security patch thus results in a long exposure of a storage or compute appliance to that vulnerability, potentially compromising the storage or compute appliance.

The above-described background relating to CVEs is merely intended to provide a contextual overview of some current issues and is not intended to be exhaustive. Other contextual information may become further apparent upon review of the following detailed description.

### BRIEF DESCRIPTION OF DRAWINGS

FIG. 1 is a block diagram of an example system in accordance with one or more example embodiments described herein.

FIG. 2 is a block diagram of example computer executable components in accordance with one or more example embodiments described herein.

FIG. 3 is a block diagram of example computer executable components in accordance with one or more example embodiments described herein.

FIGS. 4A and 4B are block flow diagrams of example dynamic adjustment of system configuration in accordance with one or more example embodiments described herein.

FIG. 5 is a block flow diagram of example dynamic adjustment of system configuration in accordance with one or more example embodiments described herein.

FIG. 6 is a block flow diagram for a process associated with dynamic adjustment of system configuration over a remote interface in response to vulnerabilities or exposures in accordance with one or more example embodiments described herein.

FIG. 7 is a block flow diagram for a process associated with dynamic adjustment of system configuration over a remote interface in response to vulnerabilities or exposures in accordance with one or more example embodiments described herein.

FIG. 8 is a block flow diagram for a process associated with dynamic adjustment of system configuration over a remote interface in response to vulnerabilities or exposures in accordance with one or more example embodiments described herein.

FIG. 9 is an example, non-limiting computing environment in which one or more embodiments described herein can be implemented.

FIG. 10 is an example, non-limiting networking environment in which one or more embodiments described herein can be implemented.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

As alluded to above, system response to CVEs can be improved in various ways, and various embodiments are described herein to this end and/or other ends.

According to an example embodiment, a system can comprise at least one processor, and at least one memory that stores executable instructions that, when executed by the at least one processor, facilitate performance of operations, comprising receiving, from a supplier entity device associated with a remote appliance device, a remote appliance device configuration update applicable to a common vulnerability and exposure (CVE) publication applicable to the remote appliance device, and applying the remote appliance device configuration update to the remote appliance device.

In one or more example embodiments, the remote appliance device configuration update can be applied to the remote appliance device via a transmission, of an updated configuration profile, to the remote appliance device.

In one or more example embodiments, the remote appliance device configuration update can be applied to the remote appliance device via a defined extended berkeley packet filter (eBPF) process.

In one or more example embodiments, the CVE publication can be identified, based on input from a CVE entity registered with the system, as being associated with the supplier entity device or the remote appliance device. In this regard, the supplier entity device can receive publication data representative of the CVE publication from a computing device associated with the CVE entity. Further in this regard, the supplier entity device can determine a group of remote appliance devices, comprising the remote appliance device, that are exposed to the CVE publication. Further in this regard, the supplier entity device can send the remote appliance device configuration update to each remote appliance device of the group of remote appliance devices.

In one or more example embodiments, the above operations can further comprise transmitting, to the supplier entity device, an acknowledgement that the remote appliance device configuration update has been applied to the remote appliance device.

In one or more example embodiments, the remote appliance device configuration update can be received via a defined secure communication channel between the supplier entity device and the remote appliance device.

In another example embodiment, a non-transitory machine-readable medium can comprise executable instructions that, when executed by at least one processor, facilitate performance of operations, comprising receiving, from a supplier device associated with a remote device, a remote device configuration update applicable to a defined vulnerability applicable to the remote device, and applying the remote device configuration update to the remote device.

In one or more example embodiments, the defined vulnerability can be registered with a defined vulnerability data store associated with the supplier device. In this regard, the defined vulnerability data store can comprise a common vulnerability and exposure data store.

In one or more example embodiments, the remote device configuration update can comprise at least one of a first update relating to a file permission change on the remote device, a second update relating to a user permission change on the remote device, a third update relating to an opening or a closing of a port of the remote device, or a fourth update relating to an enabling or a disabling of a feature of the remote device.

In one or more example embodiments, the remote device configuration update can be applied to a kernel of the remote device.

In one or more example embodiments, the remote device can comprise cloud computing equipment.

In one or more example embodiments, the remote device can comprise a storage appliance or a compute appliance.

In yet another example embodiment, a method can comprise receiving, by a device comprising at least one processor, a common vulnerability and exposure (CVE) publication applicable to a remote appliance device communicatively coupled to the device, determining, by the device, a group of remote appliance devices, comprising the remote appliance device, that are exposed to a CVE identified in the CVE publication, and in response to determining, based on the CVE, a configuration update applicable to the group of remote appliance devices, transmitting, by the device, the configuration update to the group of remote appliance devices.

In one or more example embodiments, the remote appliance device can apply the configuration update to the remote appliance device in response to the transmitting of the configuration update.

In one or more example embodiments, the transmitting of the configuration update can comprise transmitting the configuration update via a defined secure communication channel between the device and the remote appliance device.

In one or more example embodiments, the device and the remote appliance device can be located within different respective physical structures.

Consider, for instance, a remote appliance device that maintains an always-on secure connectivity channel to the appliance's corresponding supplier (e.g., supplier entity device). This connectivity can be utilized for support and monitoring of the remote appliance device. Storage and compute appliances (e.g., remote appliance devices) utilize an operating system (OS), for instance, to manage and enable interfaces to the underlying hardware of the remote appliance device. In most cases, the OSs used in enterprise appliances are Linux-based (e.g., FreeBSD). This enables enterprises to leverage a powerful, flexible, and cost-effective solution for their appliance needs.

One impactful downside to leveraging Linux-based operating systems is that any CVEs that are discovered in the underlying operating system would also be inherently present in the remote appliance device. Upon a determination that a remote appliance device is vulnerable to a CVE, the vulnerability should be addressed in a timely manner, for instance, to eliminate the exposure of the respective remote appliance device to the CVE. In some industries, it is even a legal requirement to address CVEs within a defined time frame, and response to CVEs can also be part of a service level agreement (SLA) and/or vendor agreement. However, it is challenging to generate a security patch in a short amount of time. For example, there can be significant development and validation time required to update the code of an underlying FreeBSD operating system or another suitable operating system.

Eliminating or minimizing the exposure to a CVE is another means of addressing the CVE. Eliminating or minimizing exposure is typically applied through an update to system configuration, for instance, to no longer be susceptible to the CVE. However, for a supplier that has thousands of customers, each with multiple appliances in a variety of disparate locations, it is logistically impractical or even impossible to manually update to system configurations, thus illuminating a technical problem solved by one or more embodiments described herein. It is noted that embodiments herein are applicable, for instance, to CVE exposures that can be mitigated or eliminated through system configuration updates.

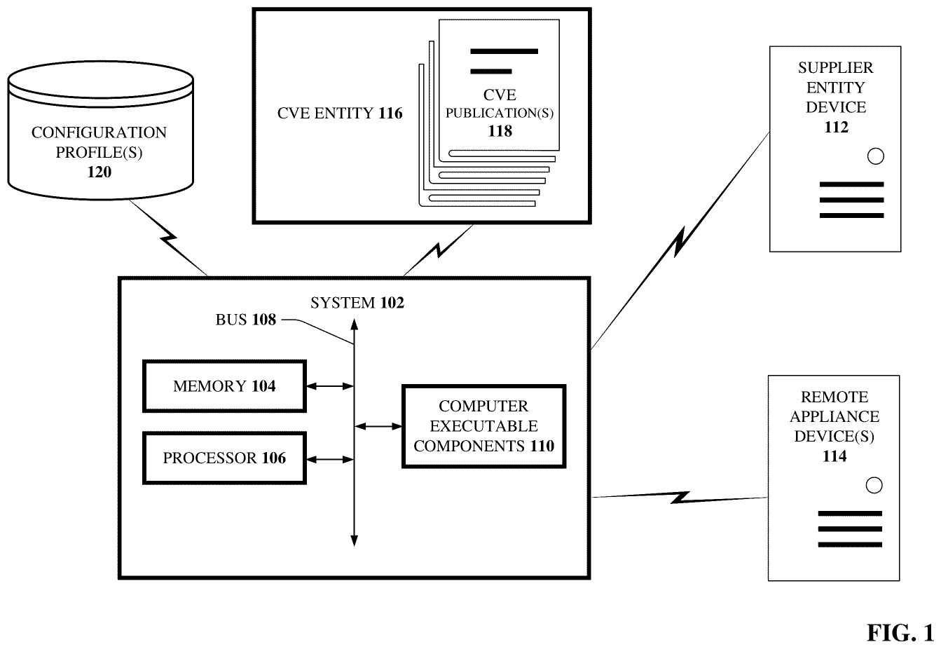

Turning now to FIG. 1, there is illustrated an example, non-limiting system 102 in accordance with one or more example embodiments herein. System 102 can comprise a computerized tool, which can be configured to perform various operations relating to dynamic adjustment of system configuration (e.g., of remote appliance devices described herein). The system 102 can comprise one or more of a variety of components, such as memory 104, processor 106, bus 108, and/or computer executable components 110. In various embodiments, one or more of the memory 104, processor 106, bus 108, and/or computer executable components 110 can be communicatively or operably coupled (e.g., over a bus or wireless network) to one another to perform one or more functions of the system 102. In various example embodiments, the system 102 can comprise and/or be communicatively coupled to a supplier entity device 112, one or more remote appliance devices 114, a CVE entity 116, and/or one or more configuration profiles 120 (e.g., a data store of configuration profiles 120 applicable to remote appliance devices 114 herein). In further embodiments, the supplier entity device 112 and/or the remote appliance device 114 can comprise respective instances of the system 102. A supplier entity device 112 can comprise a computer, server, mobile device, or another suitable device.

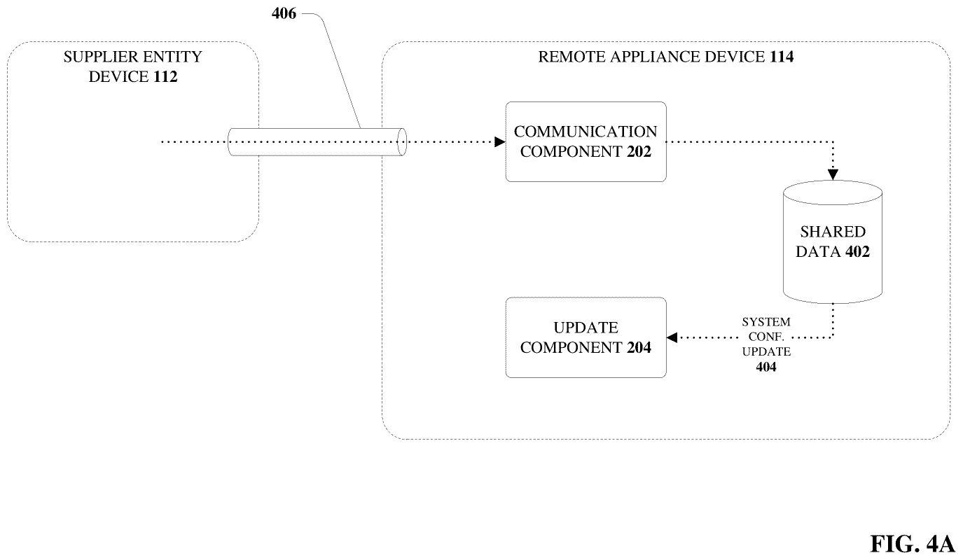

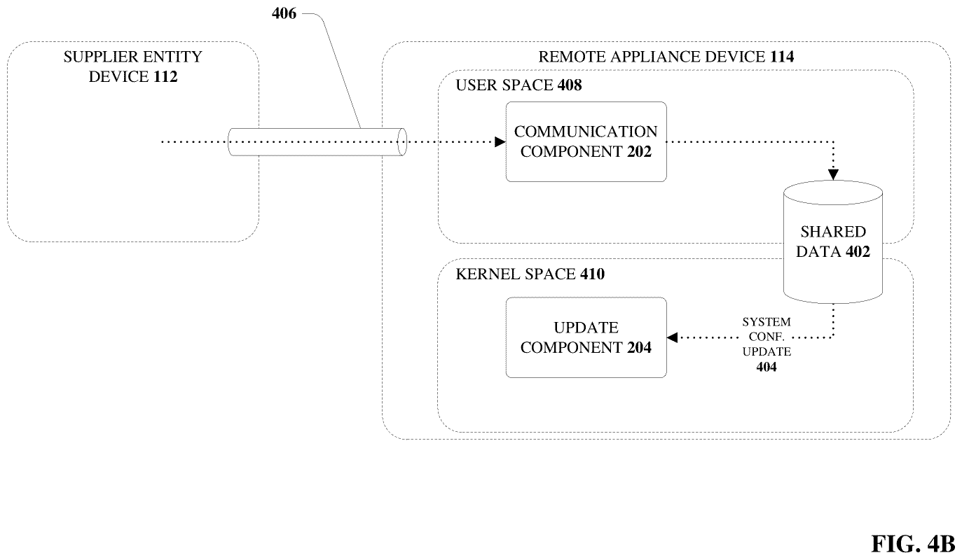

In one or more example embodiments, the remote appliance device 114 can comprise a storage appliance, a compute appliance, or any suitable device that utilizes an operating system. Storage appliances herein can comprise hardware devices that provide data storage and management capabilities. Compute appliances herein can comprise hardware devices that enable processing and computing operations. In various example embodiments, the remote appliance device 114 can comprise cloud computing equipment. Thus, the supplier entity device 112 can enable remote support and monitoring (e.g., via the secure communication channel 406 as later discussed in greater detail with reference to FIG. 4) of the remote appliance device 114.

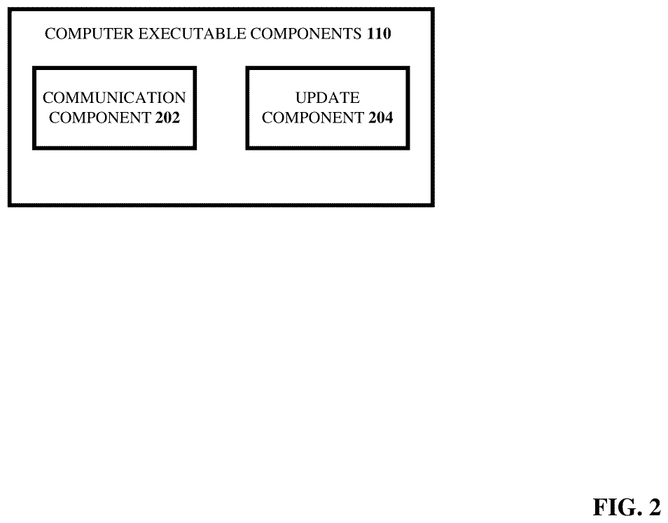

FIG. 2 illustrates a block diagram of example, non-limiting computer executable components 110 that can facilitate dynamic adjustment of system configuration in accordance with one or more embodiments described herein. Repetitive description of like elements employed in other embodiments described herein is omitted for sake of brevity. As shown in FIG. 2, the one or more computer executable components 110 can comprise communication component 202 and/or update component 204.

In various example embodiments, the communication component 202 can receive, from a supplier entity device 112 associated with a remote appliance device 114, a remote appliance device configuration update applicable to a CVE publication 118 (e.g., a defined vulnerability) applicable to the remote appliance device 114. It is noted that the remote appliance device configuration update can comprise a change to a configuration of the remote appliance device 114, rather than a code change to the remote appliance device 114.

In various example embodiments, the remote appliance device configuration update can be received (e.g., via the communication component 202) via a defined secure communication channel (e.g., secure communication channel 406) between the supplier entity device 112 and the remote appliance device 114. The secure communication channel 406 can comprise, for instance, a private and protected pathway between the supplier entity device 112 and the remote appliance device 114. In one or more embodiments, data transmitted via the secure communication channel 406 can be encrypted and/or enable end-to-end security. In one or more example embodiments, the defined vulnerability (e.g., CVE publication 118) can be registered with a defined vulnerability data store (e.g., locally stored and/or remotely available via communicative connection) associated with the supplier entity device 112. In this regard, the defined vulnerability data store can comprise a CVE data store.

In various example embodiments, the update component 204 can apply the remote appliance device configuration update to the remote appliance device 114. In various example embodiments, the remote appliance device configuration update can be applied (e.g., via the update component 204) to the remote appliance device 114 in response to a transmission (e.g., from the supplier entity device), of an updated configuration profile (e.g., of the configuration profiles 120), to the remote appliance device 114. In one or more embodiments, the remote appliance device configuration update can be applied (e.g., via the update component 204) to the remote appliance device 114 via a defined extended berkeley packet filter (eBPF) process. In this regard, in one or more embodiments, the update component 204 can comprise an eBPF module or component, which can enable the remote appliance device 114 to respond to storage, networking, filesystem, and/or application system calls. In this regard, in one or more example embodiments, the remote appliance device configuration update can be applied (e.g., via the update component 204) to a kernel (e.g., kernel space 410) of the remote appliance device 114. The eBPF framework can also verify the modules or components to be executed, for instance, to ensure that the modules or components do not compromise the security of the kernel space 410 (e.g., the modules or components can operate within a controlled environment of the kernel space 410 but still have access and can respond to low level events that take place in the kernel space 410). It is noted, however, that embodiments herein are not limited to utilization of eBPF. For instance, the update component 204 can run in a user space 408 and still receive instructions from the communication component 202 before making changes to the system configuration.

In various example embodiments, the remote appliance device configuration update can comprise one or more of a variety of configuration changes applicable to the remote appliance device 114. For instance, the remote appliance device configuration update can comprise an update relating to a file permission change on the remote appliance device 114, an update relating to a user permission change on the remote appliance device 114, an update relating to an opening or a closing of a port of the remote appliance device 114, an update relating to an enabling or a disabling of a feature of the remote appliance device 114, and/or another suitable remote appliance device configuration update applicable to the remote appliance device 114.

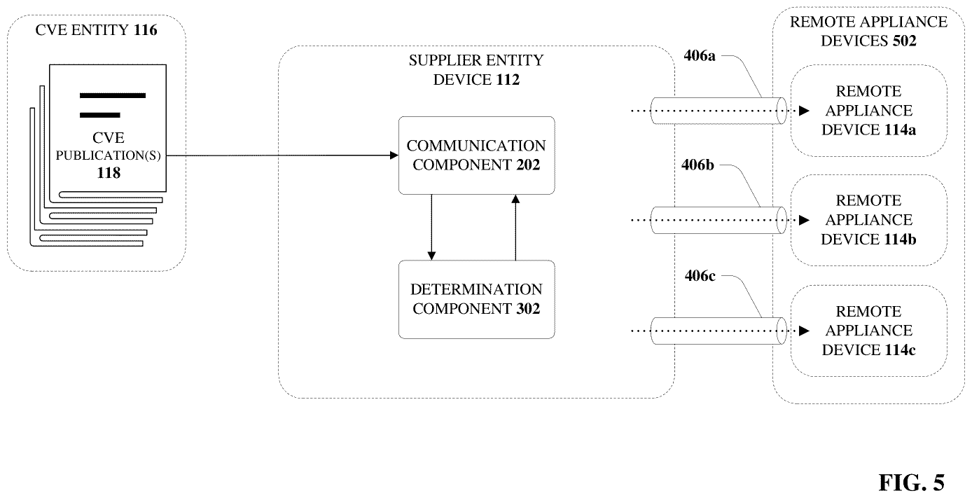

In various example embodiments, the CVE publication 118 can be identified, based on input from a CVE entity 116 registered with the system 102, as being associated with the supplier entity device 112 or the remote appliance device 114. For instance, a CVE entity 116 herein can comprise the MITRE Corporation and/or a corresponding device of the MITRE Corporation. It is noted that the MITRE Corporation maintains a database of published vulnerabilities. It is further noted, however, that CVE entities herein are not limited to MITRE CVE entities. Other example CVE entities can comprise the National Vulnerability Database, Exploit Database, CERT/CC, or another suitable CVE entity. In various example embodiments, the supplier entity device can receive publication data representative of the CVE publication 118 from a computing device associated with the CVE entity 116. It is noted that in some embodiments, the CVE entity 116 can comprise said computing device. In further example embodiments, the supplier entity device 112 can determine a group of remote appliance devices (e.g., remote appliance devices 502 as later discussed in greater detail with reference to FIG. 5), comprising the remote appliance device 114, that are exposed to the CVE publication 118. For example, a group of the same model of remote appliance device 114 can all be exposed to a common CVE publication 118. In this regard, the supplier entity device 112 can send the remote appliance device configuration update to each remote appliance device 114 of the group of remote appliance devices 502.

In various example embodiments, the communication component 202 can transmit, to the supplier entity device 112, an acknowledgement that the remote appliance device configuration update has been applied to the remote appliance device 114. In this regard, the communication component 202 can transmit the acknowledgement via the secure communication channel 406. In various example embodiments, the acknowledgement can comprise an indication of a successful application of the remote appliance device configuration update.

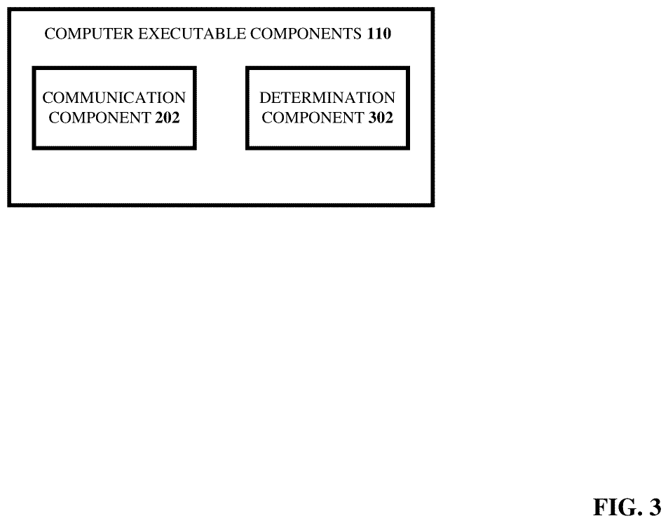

FIG. 3 illustrates a block diagram of example, non-limiting computer executable components 110 that can facilitate dynamic adjustment of system configuration in accordance with one or more embodiments described herein. Repetitive description of like elements employed in other embodiments described herein is omitted for sake of brevity. As shown in FIG. 3, the one or more computer executable components 110 can comprise communication component 202 and/or determination component 302.

In various example embodiments, the communication component 202 can receive a CVE publication 118 applicable to a remote appliance device 114 communicatively coupled to a device (e.g., a supplier entity device 112). For example, the supplier entity device 112 and/or a CVE entity 116 can be registered with one another so that CVE publications 118 can be automatically pushed from the CVE entity 116 to the supplier entity device 112 via the communication component 202 of the supplier entity device 112.

In various example embodiments, the determination component 302 can determine a group of remote appliance devices (e.g., remote appliance devices 502), comprising the remote appliance device 114, that are exposed to a CVE identified in the CVE publication 118. In this regard, the remote appliance devices 502 can be registered with the supplier entity device 112, and the determination component 302 can compare remote appliance device registrations (e.g., and corresponding data such as model number, serial number, software version, etc.) to corresponding data in the CVE publication 118 in order to determine the remote appliance devices 502 that are subject to the CVE publication 118.

In various example embodiments, the communication component 202 can then, in response to determining (e.g., via the system 102), based on the CVE, a configuration update applicable to the group of remote appliance devices 502, transmit the configuration update to the group of remote appliance devices 502. In one or more example embodiments, each respective remote appliance device 114 can then apply the configuration update (e.g., via its respective update component 204) in response to the transmitting (and receiving) of the applicable remote device configuration update. It is noted that the transmitting (e.g., via the communication component 202) of the configuration update can comprise transmitting the configuration update via a defined secure communication channel 406 between the supplier entity device 112 and the remote appliance device 114. It is further noted that the supplier entity device 112 and the remote appliance device 114 can be located within different respective physical structures (e.g., different buildings). For instance, the supplier entity device 112 can be located in state A, and the group of remote appliance devices 502 can be scattered across states A, B, C, and D in respective physical structures (e.g., buildings).

FIGS. 4A and 4B are block flow diagrams of example dynamic adjustment of system configuration in accordance with one or more example embodiments described herein. Embodiments herein can comprise an embedded program (e.g., via the update component 204) in the kernel space 410 of the remote appliance device 114, for instance, to respond to CVE events. The always-on, secure connectivity (e.g., via the secure communication channel 406) can be leveraged, for instance, to eliminate or minimize the exposure to a CVE in an automated manner, without user (e.g., customer) involvement, thus, avoiding a lengthy security patch development and validation process and/or manual workarounds. Because the secure communication channel 406 is always-on, configuration updates, once available from the supplier entity device 112, can be immediately transmitted from the supplier entity device 112 to the remote appliance device. This enables configuration changes and updates to be applied significantly faster than otherwise possible, thus mitigating exposure to CVEs and protecting remote appliance devices 114 described herein.

For example, the communication component 202 of a remote appliance device 114 can receive a configuration update from the supplier entity device 112 over the secure communication channel 406. The communication component 202 can then make instructions contained in the configuration update available to update component 204 via shared data 402 (e.g., shared memory) between the communication component 202 and the update component 204. The shared data 402 can enable, for instance, data to pass between a user space 408 of the remote appliance device 114 and a kernel space 410 of the remote appliance device 114. The update component 204 can then retrieve instructions (e.g., system configuration update 404) from shared data 402 and apply the configuration changes to the remote appliance device 114, for instance, to eliminate/minimize exposure to CVE. Such configuration changes can comprise, for example, an update relating to a file permission change on the remote appliance device 114, an update relating to a user permission change on the remote appliance device 114, an update relating to an opening or a closing of a port of the remote appliance device 114, an update relating to an enabling or a disabling of a feature of the remote appliance device 114, and/or another suitable remote appliance device configuration update applicable to the remote appliance device 114.

FIG. 5 is a block flow diagram of example dynamic adjustment of system configuration in accordance with one or more example embodiments described herein. For example, a CVE can be identified and/or published via a CVE entity 116 (e.g., a computer, server, mobile device, or another suitable device). For example, the supplier entity device 112 and/or a CVE entity 116 can be registered with one another so that CVE publications 118 can be automatically pushed from the CVE entity 116 to the supplier entity device 112 via the communication component 202 of the supplier entity device 112. In this regard, the supplier entity device 112 can be notified (e.g., via the CVE entity 116) of a corresponding CVE publication 118. For example, the supplier entity device 112 can receive a CVE publication 118. The supplier entity device 112 can identify remote appliance devices 114 that are exposed to the respective CVE. For example, the determination component 302 can determine a group of remote appliance devices (e.g., remote appliance devices 502), comprising the remote appliance device 114, that are exposed to a CVE identified in the CVE publication 118. In this regard, the remote appliance devices 502 can be registered with the supplier entity device 112, and the determination component 302 can compare remote appliance device registrations (e.g., and corresponding data such as model number, serial number, software version, etc.) to corresponding data in the CVE publication 118 in order to determine the remote appliance devices 502 that are subject to the CVE publication 118. System configuration updates (e.g., applicable to the identified vulnerable remote appliance devices(s) 114) that eliminate exposure to this CVE can be determined, and the supplier entity device 112 can then push these system configuration updates to corresponding remote appliance devices 502 via respective secure communication channel(s) 406. For example, the supplier entity device 112 can send the remote appliance configuration update to the remote appliance device 114a via the secure communication channel 406a, the supplier entity device 112 can send the remote appliance configuration update to the remote appliance device 114b via the secure communication channel 406b, the supplier entity device 112 can send the remote appliance configuration update to the remote appliance device 114c via the secure communication channel 406c, and so on.

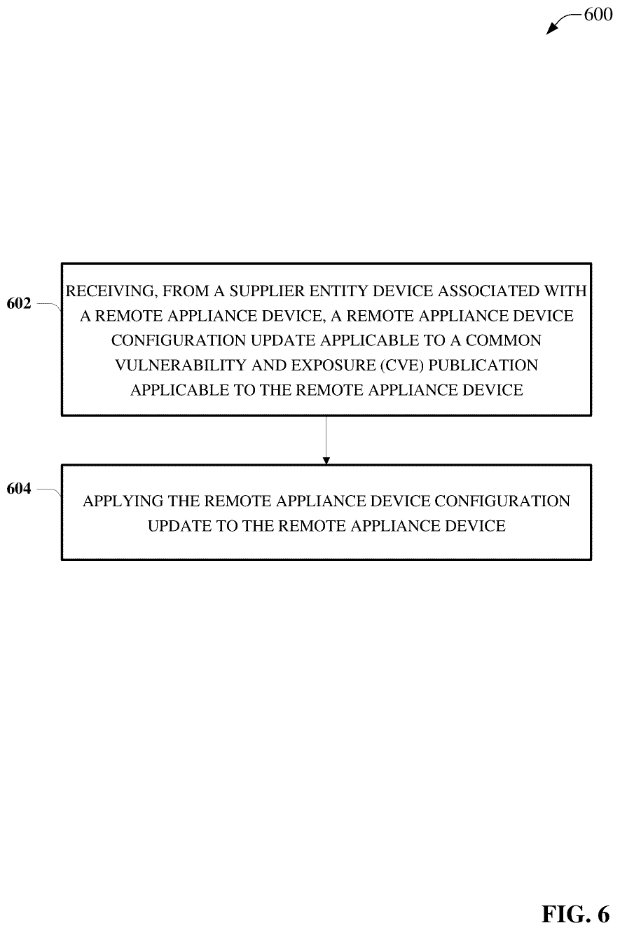

FIG. 6 illustrates a block flow diagram for a process 600 associated with dynamic adjustment of system configuration over a remote interface in response to vulnerabilities or exposures in accordance with one or more embodiments described herein. At 602, the process 600 can comprise receiving (e.g., via the communication component 202), from a supplier entity device 112 associated with a remote appliance device 114, a remote appliance device configuration update applicable to a CVE publication applicable to the remote appliance device 114. At 604, the process 600 can comprise applying (e.g., via the update component 204) the remote appliance device configuration update to the remote appliance device 114.

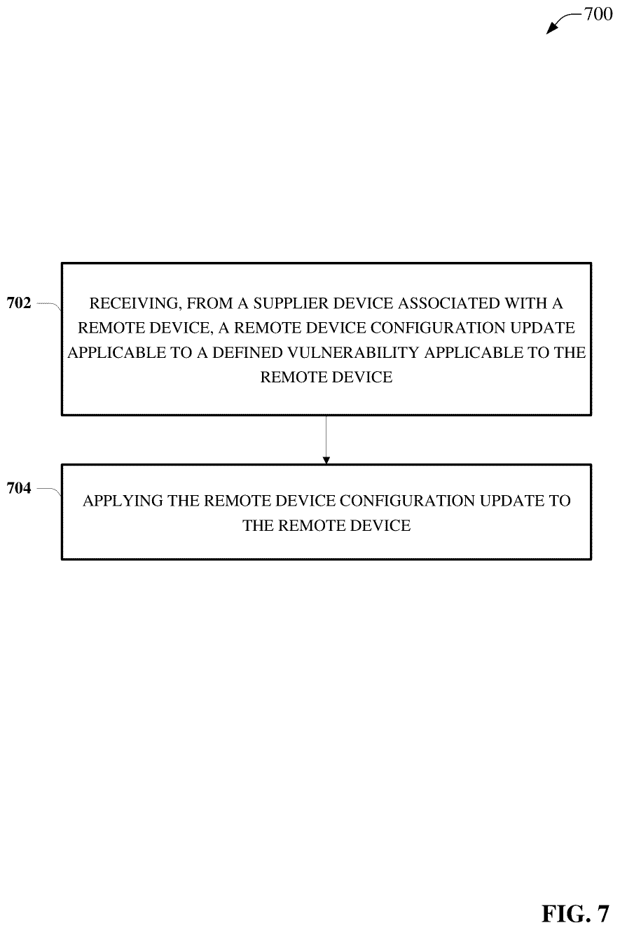

FIG. 7 illustrates a block flow diagram for a process 700 associated with dynamic adjustment of system configuration over a remote interface in response to vulnerabilities or exposures in accordance with one or more embodiments described herein. At 702, the process 700 can comprise receiving(e.g., via the communication component 202), from a supplier device (e.g., supplier entity device 112) associated with a remote device (e.g., remote appliance device 114), a remote device configuration update applicable to a defined vulnerability applicable to the remote device (e.g., remote appliance device 114). At 702, the process 700 can comprise applying (e.g., via the update component 204) the remote device configuration update to the remote device (e.g., remote appliance device 114).

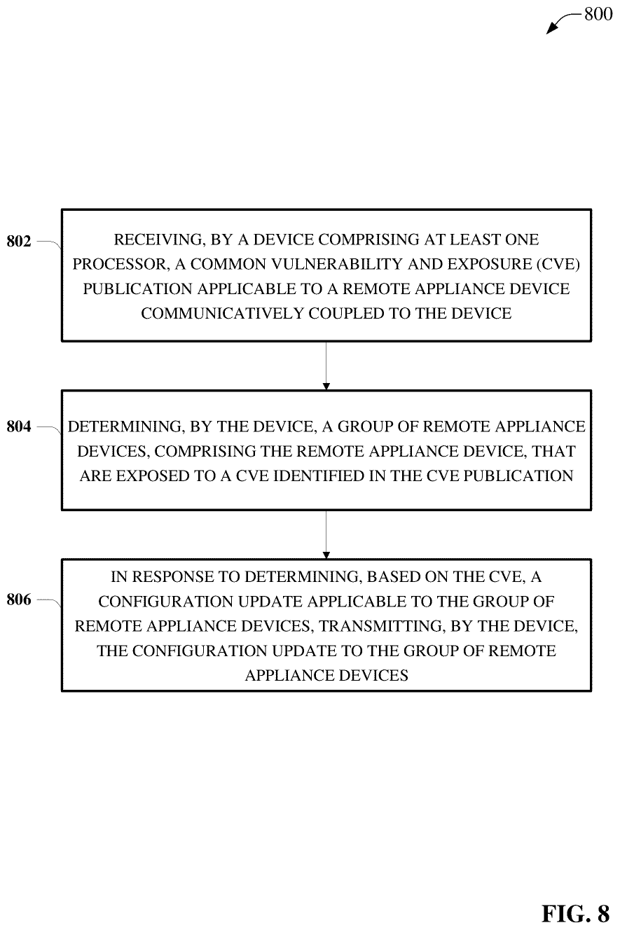

FIG. 8 illustrates a block flow diagram for a process 800 associated with dynamic adjustment of system configuration over a remote interface in response to vulnerabilities or exposures in accordance with one or more embodiments described herein. At 802, the process 800 can comprise receiving (e.g., via the communication component 202), by a device (e.g., supplier entity device 112) comprising at least one processor (e.g., processor 106), a CVE publication 118 applicable to a remote appliance device 114 communicatively coupled to the device (e.g., supplier entity device 112). At 804, the process 800 can comprise determining (e.g., via the determination component 302), by the device (e.g., supplier entity device 112), a group of remote appliance devices 502, comprising the remote appliance device 114, that are exposed to a CVE identified in the CVE publication 118. At 806, the process 800 can comprise, in response to determining, based on the CVE, a configuration update applicable to the group of remote appliance devices 502, transmitting (e.g., via the communication component 202), by the device (e.g., supplier entity device 112), the configuration update to the group of remote appliance devices 502.

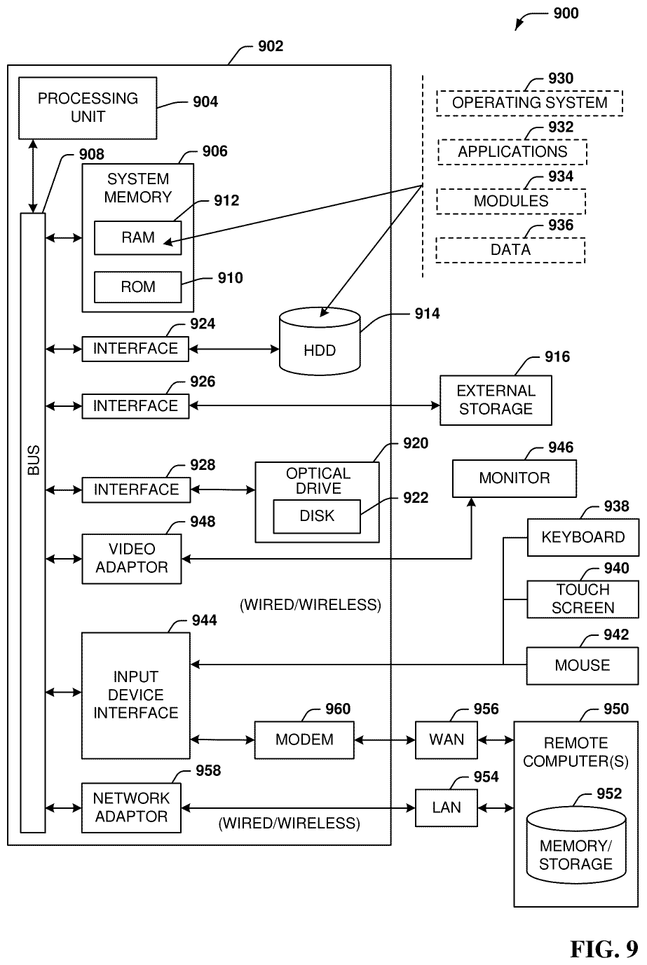

In order to provide additional context for various embodiments described herein, FIG. 9 and the following discussion are intended to provide a brief, general description of a suitable computing environment 900 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IOT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared, and other wireless media.

With reference again to FIG. 9, the example environment 900 for implementing various embodiments of the aspects described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes ROM 910 and RAM 912. A basic input/output system (BIOS) can be stored in a non-volatile memory such as ROM, erasable programmable read only memory (EPROM), EEPROM, which BIOS contains the basic routines that help to transfer information between elements within the computer 902, such as during startup. The RAM 912 can also include a high-speed RAM such as static RAM for caching data.

The computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and an optical disk drive 920 (e.g., which can read or write from a disk 922, such as a CD-ROM disc, a DVD, a BD, etc.). While the internal HDD 914 is illustrated as located within the computer 902, the internal HDD 914 can also be configured for external use in a suitable chassis (not shown). Additionally, while not shown in environment 900, a solid-state drive (SSD) could be used in addition to, or in place of, an HDD 914. The HDD 914, external storage device(s) 916 and optical disk drive 920 can be connected to the system bus 908 by an HDD interface 924, an external storage interface 926 and an optical drive interface 928, respectively. The interface 924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an embodiment, operating system 930 can comprise one virtual machine (VM) of multiple VMs hosted at computer 902. Furthermore, operating system 930 can provide runtime environments, such as the Java runtime environment or the . NET framework, for applications 932. Runtime environments are consistent execution environments that allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and settings for an application.

Further, computer 902 can be enabled with a security module, such as a trusted processing module (TPM). For instance, with a TPM, boot components hash next in time boot components, and wait for a match of results to secured values, before loading a next boot component. This process can take place at any layer in the code execution stack of computer 902, e.g., applied at the application execution level or at the operating system (OS) kernel level, thereby enabling security at any level of code execution.

A user can enter commands and information into the computer 902 through one or more wired/wireless input devices, e.g., a keyboard 938, a touch screen 940, and a pointing device, such as a mouse 942. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 944 that can be coupled to the system bus 908, but can be connected by other interfaces, such as a parallel port, an IEEE 1394 serial port, a game port, a USB port, an IR interface, a BLUETOOTH® interface, etc.

A monitor 946 or another type of display device can also be connected to the system bus 908 via an interface, such as a video adapter 948. In addition to the monitor 946, a computer typically includes other peripheral output devices (not shown), such as speakers, printers, etc.

The computer 902 can operate in a networked environment using logical connections via wired and/or wireless communications to one or more remote computers, such as a remote computer(s) 950. The remote computer(s) 950 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 952 is illustrated. The logical connections depicted include wired/wireless connectivity to a local area network (LAN) 954 and/or larger networks, e.g., a wide area network (WAN) 956. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the local network 954 through a wired and/or wireless communication network interface or adapter 958. The adapter 958 can facilitate wired or wireless communication to the LAN 954, which can also include a wireless access point (AP) disposed thereon for communicating with the adapter 958 in a wireless mode.

When used in a WAN networking environment, the computer 902 can include a modem 960 or can be connected to a communications server on the WAN 956 via other means for establishing communications over the WAN 956, such as by way of the Internet. The modem 960, which can be internal or external and a wired or wireless device, can be connected to the system bus 908 via the input device interface 944. In a networked environment, program modules depicted relative to the computer 902 or portions thereof, can be stored in the remote memory/storage device 952. It will be appreciated that the network connections shown are examples and other means of establishing a communications link between the computers can be used.

When used in either a LAN or WAN networking environment, the computer 902 can access cloud storage systems or other network-based storage systems in addition to, or in place of, external storage devices 916 as described above. Generally, a connection between the computer 902 and a cloud storage system can be established over a LAN 954 or WAN 956 e.g., by the adapter 958 or modem 960, respectively. Upon connecting the computer 902 to an associated cloud storage system, the external storage interface 926 can, with the aid of the adapter 958 and/or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

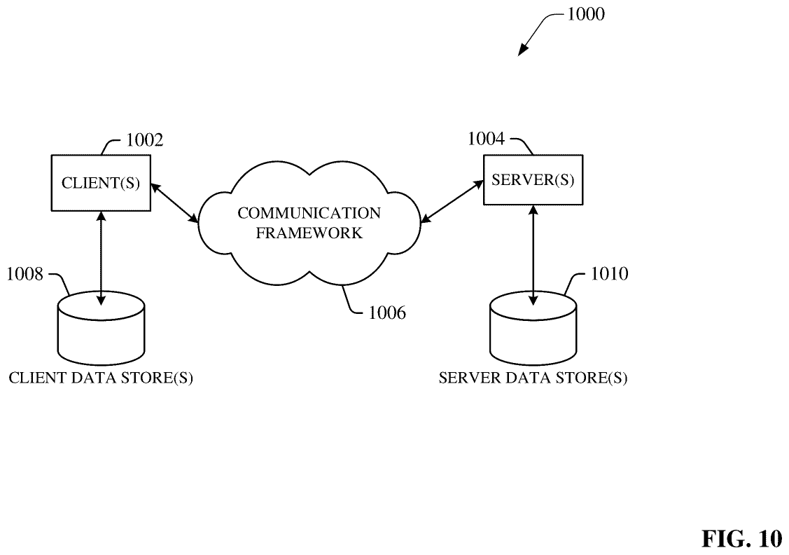

Referring now to FIG. 10, there is illustrated a schematic block diagram of a computing environment 1000 in accordance with this specification. The system 1000 includes one or more client(s) 1002, (e.g., computers, smart phones, tablets, cameras, PDA's). The client(s) 1002 can be hardware and/or software (e.g., threads, processes, computing devices). The client(s) 1002 can house cookie(s) and/or associated contextual information by employing the specification, for example.

The system 1000 also includes one or more server(s) 1004. The server(s) 1004 can also be hardware or hardware in combination with software (e.g., threads, processes, computing devices). The servers 1004 can house threads to perform transformations of media items by employing aspects of this disclosure, for example. One possible communication between a client 1002 and a server 1004 can be in the form of a data packet adapted to be transmitted between two or more computer processes wherein data packets may include coded analyzed headspaces and/or input. The data packet can include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

In one exemplary implementation, a client 1002 can transfer an encoded file, (e.g., encoded media item), to server 1004. Server 1004 can store the file, decode the file, or transmit the file to another client 1002. It is noted that a client 1002 can also transfer uncompressed files to a server 1004 and server 1004 can compress the file and/or transform the file in accordance with this disclosure. Likewise, server 1004 can encode information and transmit the information via communication framework 1006 to one or more clients 1002.

The illustrated aspects of the disclosure may also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

1. A system, comprising:
at least one processor; and
at least one memory that stores executable instructions that, when executed by the at least one processor, facilitate performance of operations, comprising:
receiving, from a supplier entity device associated with a remote appliance device, a remote appliance device configuration update applicable to a common vulnerability and exposure (CVE) publication applicable to the remote appliance device, wherein the remote appliance device configuration update comprises a change to a configuration of the remote appliance device without a code change to the remote appliance device; and
applying the remote appliance device configuration update to the remote appliance device by passing instructions of the remote appliance device configuration update from a user space to a kernel space of the remote appliance device via a shared memory that is shared between the user space and the kernel space.

2. The system of claim 1, wherein the remote appliance device configuration update is applied to the remote appliance device via a transmission, of an updated configuration profile, to the remote appliance device.

3. The system of claim 1, wherein the remote appliance device configuration update is applied to the remote appliance device via a defined extended berkeley packet filter process.

4. The system of claim 1, wherein the CVE publication has been identified, based on input from a CVE entity registered with the system, as being associated with the supplier entity device or the remote appliance device.

5. The system of claim 4, wherein the supplier entity device has received publication data representative of the CVE publication from a computing device associated with the CVE entity.

6. The system of claim 5, wherein the supplier entity device has determined a group of remote appliance devices, comprising the remote appliance device, that are exposed to the CVE publication.

7. The system of claim 6, wherein the supplier entity device has sent the remote appliance device configuration update to each remote appliance device of the group of remote appliance devices.

8. The system of claim 1, wherein the operations further comprise:
transmitting, to the supplier entity device, an acknowledgement that the remote appliance device configuration update has been applied to the remote appliance device.

9. The system of claim 1, wherein the remote appliance device configuration update is received via a defined secure communication channel between the supplier entity device and the remote appliance device.

10. A non-transitory machine-readable medium, comprising executable instructions that, when executed by at least one processor, facilitate performance of operations, comprising:
receiving, from a supplier device associated with a remote device, a remote device configuration update applicable to a defined vulnerability applicable to the remote device, wherein the remote device configuration update comprises a change to a configuration of the remote device without a code change to the remote device; and
applying the remote device configuration update to the remote device by passing instructions of the remote device configuration update from a user space to a kernel space of the remote device via a shared memory that is shared between the user space and the kernel space.

11. The non-transitory machine-readable medium of claim 10, wherein the defined vulnerability has been registered with a defined vulnerability data store associated with the supplier device.

12. The non-transitory machine-readable medium of claim 11, wherein the defined vulnerability data store comprises a common vulnerability and exposure data store.

13. The non-transitory machine-readable medium of claim 10, wherein the remote device configuration update comprises at least one of a first update relating to a file permission change on the remote device, a second update relating to a user permission change on the remote device, a third update relating to an opening or a closing of a port of the remote device, or a fourth update relating to an enabling or a disabling of a feature of the remote device.

14. The non-transitory machine-readable medium of claim 10, wherein the remote device configuration update is applied to a kernel of the remote device.

15. The non-transitory machine-readable medium of claim 10, wherein the remote device comprises cloud computing equipment.

16. The non-transitory machine-readable medium of claim 10, wherein the remote device comprises a storage appliance or a compute appliance.

17. A method, comprising:
receiving, by a device comprising at least one processor, a common vulnerability and exposure (CVE) publication applicable to a remote appliance device communicatively coupled to the device;
determining, by the device, a group of remote appliance devices, comprising the remote appliance device, that are exposed to a CVE identified in the CVE publication; and
in response to determining, based on the CVE, a configuration update applicable to the group of remote appliance devices, wherein the configuration update comprises a change to a configuration of the remote appliance devices of the group without a code change to the remote appliance devices of the group, transmitting, by the device, the configuration update to the group of remote appliance devices, wherein the remote appliance device applies the configuration update by passing instructions of the configuration update from a user space to a kernel space of the remote appliance device via a shared memory that is shared between the user space and the kernel space.

18. The method of claim 17, wherein the remote appliance device applies the configuration update to the remote appliance device in response to the transmitting of the configuration update.

19. The method of claim 17, wherein the transmitting of the configuration update comprises transmitting the configuration update via a defined secure communication channel between the device and the remote appliance device.

20. The method of claim 17, wherein the device and the remote appliance device are located within different respective physical structures.
